(19) United States
(12) Patent Application Publication
(10) Pub. No.: US 2024/0316660 A1
(43) Pub. Date: Sep. 26, 2024

(54) Saw Blade Guiding Device for a Saw, and Saw Having the Saw Blade Guiding Device

(71) Applicant: Robert Bosch GmbH, Stuttgart (DE)

(72) Inventor: Thorsten Kuehn, Eislingen (DE)

(21) Appl. No.: 18/693,703

(22) PCT Filed: Sep. 7, 2022
(86) PCT No.: PCT/EP2022/074789

§ 371 Date: Mar. 20, 2024

(30) Foreign Application Priority Data
Sep. 23, 2021 (DE) 10 2021 210 575.0

(51) Int. Cl. B23D 51/02

(52) U.S. Cl. CPC B23D 51/027

(57) ABSTRACT

A saw blade guiding device for a saw, in particular a jig saw, includes at least one guide unit for guiding a saw blade of the saw in a sawing operation. The guide unit has two guide elements, which are provided to together form a guide holder for the saw blade, wherein a width of the guide holder is adjustable by the two guide elements. At least one guide element of the two guide elements has, on a side facing the other guide element, at least two guide faces, each of which is provided to form a side face of the guide holder. The at least two guide faces are offset with respect to one another at least substantially parallel to an extent of the width the guide holder.

### THE PRIOR ART

A saw blade guiding device for a saw, comprising at least one guide unit for guiding a saw blade of the saw in a sawing operation, has already been proposed whereby the guide unit comprises two guide elements which are provided to together form a guide holder for the saw blade, whereby a width of the guide holder can be adjusted via the two guide elements.

### DISCLOSURE OF THE INVENTION

The invention relates to a saw blade guiding device for a saw, in particular a jig saw, comprising at least one guide unit for guiding a saw blade of the saw in a sawing operation, whereby the guide unit comprises two guide elements which are provided to together form a guide holder for the saw blade, in particular an untoothed saw blade back, whereby a width of the guide holder is adjustable via the two guide elements.

It is proposed that at least one guide element of the two guide elements has, on a side facing the other guide element of the two guide elements, at least two guide faces, each of which is provided to form a side face of the guide holder, in particular depending on a guiding position of the guide element, the at least two guide faces of the guide element being arranged offset with respect to one another at least substantially parallel to an extent of the width of the guide holder.

In particular, the at least two guide faces are designed displaced with respect to one another in an offset direction. The term “substantially parallel” is in particular understood to mean an orientation of a straight line, a plane or a direction, in particular an offset direction in which the at least two guide faces are designed displaced with respect to one another, relative to another straight line, another plane or a reference direction, in particular a straight line which includes the width of the guide holder, whereby the straight line, the plane or the direction features a deviation of less than 8°, advantageously less than 5° and particularly advantageously less than 2°, relative to the other straight line, the other plane or the reference direction, in particular viewed in at least one projection plane, the deviation preferably caused by manufacturing imprecision. Preferably, the guide holder is delimited by at least two side faces which are in particular each designed to be at least substantially perpendicular to the offset direction and/or to the extent of the width of the guide holder. The expression “substantially perpendicular” is intended in particular to mean an orientation of a straight line, a plane or a direction, in particular of a main extension plane of one of the side faces, relative to another straight line, another plane or a reference direction, in particular the offset direction and/or a straight line which includes the width of the guide holder, whereby the straight line, the plane or the direction, and the other straight line, the other plane, or the reference direction, make an angle of 90° with a deviation of less than 8°, advantageously less than 5° and particularly advantageously less than 2°, in particular viewed in a projection plane, the deviation preferably caused by manufacturing imprecision. In particular, the guide element forms a respective side face of the guide holder via each one of the guide faces. Preferably, the other guide element forms another side face of the guide holder. Preferably, when viewed perpendicular to the guide faces, the guide faces are arranged at a distance from each other on the guide element. The guide faces are preferably at least substantially planar at least in regions. Preferably, the guide faces are designed at least in part at least substantially perpendicular to the offset direction and/or to the extent the width of the guide holder. Preferably, the width of the guide holder corresponds to a minimum spacing of the side faces of the guide holder. The side faces and/or the guide faces each have a main extension plane which, in particular, extends at least substantially perpendicular to the offset direction and/or to the extent of the width of the guide holder. The expression “main extension plane” of a structural unit is in particular intended to mean a plane which is parallel to a largest side face of a smallest notional cuboid which just completely encloses the structural unit, and which in particular runs through the center of the cuboid. Preferably, each of the guide faces of the guide element has a minimum spacing to the other guide element which is different from each of the other guide faces, in particular in each guiding position. Preferably, the guide element, in particular the guide faces, are designed such that a maximum width of the guide holder is at most 4 mm, preferably at most 3 mm, and more preferably at most 2 mm.

The saw blade guiding device is provided in particular for guiding the saw blade of the saw in a sawing operation. In particular, the side faces of the guide holder are provided to sit at least partially flat against the saw blade in at least one operating state in order to prevent the saw blade from deflecting outward. Preferably, the guide holder comprises a central plane extending perpendicular to the width of the guide holder. In particular, the guide holder is designed such that a point on the side face comprising one of the respective guide faces of the guide holder, in particular one of the two side faces of the guide holder, said point being nearest to the central plane when in a guiding position, lies within a planar surface which is oriented parallel to the central plane. Preferably, the guide holder features a U-shaped basic shape. In particular, the basic shape of the guide holder is designed to be different from a V-shaped embodiment. Particularly preferably, the guide holder is provided such that the saw blade lies flat against one of the side faces of the guide holder while being guided by the guide holder.

In particular, the guide holder is designed to be open toward at least one side, in particular a front side. Preferably, the guide holder is at least largely, in particular at least substantially completely delimited by the two guide elements, in particular the guide element and the other guide element. Preferably, the guide holder is delimited by the two guide elements at least at the two side faces of the guide holder. In particular, the two side faces of the guide holder are designed on opposite sides of the two guide elements. Preferably, the guide faces each extend at least largely along a maximum cross-sectional surface of the guide holder, the surface extending in particular at least substantially perpendicular to the offset direction and/or the extent of the width of the guide holder and/or at least substantially parallel to the central plane and/or the side faces of the guide holder. Preferably, a minimum spacing of the guide faces, in particular a spacing oriented along the offset direction, formed at least substantially parallel to the extent of the width of the guide holder, corresponds to a difference of the width of the guide holder between the various guiding positions. Preferably, the guide holder extends, in particular independently of an adjusted guiding position, at least substantially perpendicular to the extent of the width of the guide holder and/or to the offset direction, and at least substantially perpendicular to a depth of the holder recess, along a maximum main extension of at least 0.5 cm, preferably at least 1 cm, and more preferably at least 1.5 cm. In particular, the guide faces each extend at least substantially perpendicular to the extent of the width of the guide holder and/or the offset direction, and at least substantially perpendicular to a depth of the holder recess along a maximum main extension of at least 0.5 cm, preferably at least 1 cm and more preferably at least 1.5 cm. In particular, the saw blade guiding device, in particular the guide unit, can be operated to adjust the width of the guide holder without tools.

It is conceivable that the guide element and/or the other guide element each have a chamfer and/or an outer surface which is oblique relative to the main extension plane of the respective guide element, and oblique relative to the offset direction and/or to the width of the guide holder. In particular, the chamfer and/or the outer surface is provided to allow the saw blade, in particular the saw blade back, to be held by the guide holder, whereby in particular the saw blade, in particular the saw blade back, is received in the guide holder via a side of the side faces of the guide holder which comprises the chamfer and/or the outer surface.

Using the embodiment of the saw blade guiding device according to the invention, an advantageously simple and fast change of the width of the guide holder can be made possible, in particular because it is only necessary to arrange another guide face of the guide element in a region of the guide holder. By adjusting the width of the guide holder to a thickness of a saw blade to be guided, it can be advantageously prevented that the saw blade goes off course in curved sections, in particular even when relatively thin saw blades are used. An adjustable guide holder can advantageously be embodied which does not depend on a width of the guide holder which changes along a depth of the guide holder. In particular, contact points between the guide holder and the saw blade can be advantageously prevented in this way. In particular, unwanted abrasion of a guide element and/or the saw blade can be advantageously prevented. An advantageously compact saw blade guiding device with an adjustable guide holder width can be made possible, in particular since it is only the guide element that has to be moved in order to change the width of the guide holder. A U-shaped guide holder with an adjustable width can advantageously be made possible, which advantageously also allows thinner saw blades to be guided advantageously securely.

Furthermore, it is proposed that the guide element is movably mounted in order to adjust the width of the guide holder, and that it features at least two guiding positions. In the at least two guiding positions of the guide element, a respective different one of the at least two guide faces of the guide element forms a side face of the guide holder. An advantageously compact saw blade guiding device can be made possible. In particular, by moving the guide element, an advantageously fast and simple adjustment of the width of the guide holder can be made possible. In particular, the saw blade guiding device comprises at least one holding unit, the guiding element being mounted movably relative to the holding unit in order to adjust the width of the guide holder. Preferably, the guide element is movably mounted on the holding unit. Preferably, it is provided that the guide element is moved upon a change in the guiding position such that a different one of the at least two guide faces is arranged in a region of the guide holder and forms a side face of the guide holder. Preferably, each of the guide faces of the guide element has at least substantially identically the same maximum main extension. In particular, the guide faces of the guide element, in particular along the offset direction and/or the extent of the width of the guide holder, each have a basic surface, i.e. a basic shape that is at least substantially identical. In particular, the guide holder has a different value for the width of the guide holder in each of the guiding positions of the guide element. Preferably, a direction of extension of the width of the guide holder is at least substantially identical in the different guiding positions of the guide element.

In addition, it is proposed that in order to adjust the width of the guide holder, the guide element is designed to be rotatable about an axis of rotation of the guide element, whereby the at least two guide faces of the guide element are arranged in a circumferential direction offset with respect to one another about the axis of rotation. An advantageously compact saw blade guiding device can be made possible, in particular because a width of the guide holder can be advantageously changed independent of a change of external dimensions of the saw blade guiding device, in particular of the guide element. Preferably, a change in the width of the guide holder can be made possible advantageously in confined spaces, e.g. in a state in which the saw is set in place. Preferably, the rotational axis of the guide element is oriented at least substantially perpendicular to the central plane of the guide holder, to the side faces, in particular to the main extension planes of the side faces, of the guide holder and/or the guide faces, in particular to the main extension planes of the guide faces, of the guide element. Preferably, the axis of rotation of the guide element is oriented at least substantially parallel to the offset direction and/or the extent of the width of the guide holder. Preferably, the circumferential direction is formed inside of a plane extending perpendicular to the axis of rotation. The guide unit comprises at least one bearing element, in particular a pin, a bolt, a passage or the like, for providing rotatable support of the guide element. Preferably, the bearing element is provided to rotatably mount the guide element on the holding unit. Preferably, the bearing element extends at least substantially parallel to the axis of rotation. Preferably, the guide element is at least substantially plate-shaped and/or disk-shaped. In particular, the guide element features, at least substantially perpendicular to the axis of rotation, a maximum transverse extension which, in particular, is greater than a maximum height of the guide element extending at least substantially parallel to the axis of rotation. It is conceivable that the guide holder extends, radially relative to the axis of rotation, up to the axis of rotation and/or the up to the bearing element or is at a distance from the axis of rotation and/or the bearing element. Preferably, the guide unit comprises actuating means for actuating the guide element in order to adjust the width of the guide holder. The actuating means are preferably provided for actuation by a user given rotation of the guide element about the axis of rotation. In particular, the actuating means are arranged on the guide element in an evenly distributed manner about the axis of rotation. Particularly preferably, the actuating means are designed to be integral with the guide element or are formed by the guide element. In particular, the guide unit, in particular the guide element, can be actuated without tools to adjust the width of the guide holder.

It is also proposed that the saw blade guiding device comprises at least one, in particular the aforementioned, holding unit, which is at least substantially fixed to the housing in order to retain the guide unit, whereby the guide unit comprises at least one fixing means, the guide element being movably mounted relative to the holding unit in order to adjust the width of the guide holder, the fixing means being provided to fix the guide element in at least one of the guiding positions relative to the holding unit. Advantageously, a simple and intuitive operation of the saw blade guiding device for changing the width of the guide holder can be achieved. An advantageously simple embodiment of the guide element and the holding unit can be made possible in order to fix the guide element. The at least one fixing means is preferably provided to connect the guide element to the holding unit, in particular to a holding element of the holding unit in order to fix the guide element relative to the holding unit in an interlocking and/or frictional manner. The holding unit, in particular the holding element, is preferably provided to surround the guide element, as viewed perpendicular to the axis of rotation. It is conceivable that the other guide element be designed to be integral with the holding unit, in particular with the holding element. The term “integrally” is in particular understood to mean a bonded connection, e.g., by means of a welding process and/or an adhesive process, etc. and particularly advantageously integrally formed via manufacture from a casting and/or via manufacture in a single-component or multiple-component injection molding process. It is alternatively conceivable that the holding unit, in particular the holding element, is provided to surround the guide element, as viewed perpendicular to the axis of rotation.

It is further proposed that the guide unit comprise a plurality of fixing means arranged on the guide element, the individual fixing means being provided to fix the guide element in one of the guiding positions in a frictional and/or interlocking manner. Advantageously secure and robust fixing of the guide element can be achieved. In particular, unwanted shifting of the guide holder and/or tilting of the saw blade inside the guide holder can be advantageously prevented. In addition, a plurality of guiding positions of the guide element having different widths of the guide holder can be advantageously easily made possible, whereby the guide element can be fixed in each guiding position. Preferably, the fixing means are designed as catch elements for a catch connection, as friction surfaces or the like. Preferably, the fixing means are designed to be projections which are integrally formed with the guide element, the projections being arranged in particular at a distance from the axis of rotation. The holding unit, in particular the holding element, preferably delimits at least one recess, which is provided to cooperate with the fixing means in order to fix the guide element. The holders of the holding unit are preferably provided to receive at least one fixing means via a movement of the holder and/or the fixing means in a direction oriented at least substantially parallel to the axis of rotation, the fixing means in particular being at least partially arranged inside the holder. In particular, the fixing means are arranged on the guide element distributed around the axis of rotation. In particular, the holder of the holding unit is provided to cooperate with a respectively different one of the fixing means, depending on a guiding position to be adjusted. Preferably, the fixing means are arranged on a side of the guide element which faces away from a side of the guide element which comprises the guide faces. In particular, each of the fixing means extends from an outer surface of the guide element in a direction oriented at least substantially parallel to the axis of rotation and/or the offset direction, in particular away from the respective outer surface of the guide element. In particular, a number of the fixing means corresponds to at least a number of guide faces of the guide element. In particular, the guide unit comprises at least two fixing means. Alternatively, it is conceivable that the fixing means are designed as recesses delimited by the guide element. In particular, the holding unit, in particular the holding element, comprises at least one projection, which is provided to fix the guide element relative to the holding unit in order to cooperate with one of the recesses delimited by the guide element. The guide element is preferably designed to be fixed relative to the holding unit in one of the guiding positions of the guide element, in particular via the fixing means.

It is further proposed that the guide unit comprise at least one reset element, which is provided to counteract movement of the guide element from one of the guiding positions. Advantageously, automatic fixing of the guide element via the fixing means can be achieved, in particular independent of user activity. An advantageously high degree of safety can be achieved this way. In particular, unwanted shifting and/or guidance of the saw blade coming loose due to improper and/or incorrect use of the saw blade guiding device can be advantageously prevented. The guide element is preferably provided to be moved at least substantially parallel to the axis of rotation and/or the offset direction in order to move from one of the guiding positions, whereby in particular an interlocking and/or frictional connection of the guide element and the holding unit is disengaged via the fixing means. The reset element is particularly provided to apply a resetting force to the guide element against movement along the axis of rotation. For example, the reset element is designed as a spring, in particular a compression or tension spring, as a magnet, or the like. In particular, the reset element is arranged between the guide element and the other reset element or the holding unit, in particular the holding element. Preferably, the reset element is arranged on the bearing element. The bearing element is in particular provided to hold, in particular to center, the reset element relative to the axis of rotation. The reset element preferably extends at least substantially parallel to the axis of rotation. The reset element is preferably arranged at a distance from the guide holder and the guide faces. In particular, the reset element is, via the reset force, provided to retain the guide element and the holding unit, in particular the holding element, in a state of connection to one another via the fixing means. Alternatively, it is conceivable that the guide element be movable at least substantially parallel to the axis of rotation and/or the direction of offsetting via a screw thread. In particular, the guide element is connected to the bearing element, to the holding unit, in particular the holding element, and/or to the other guide element via a screw thread. The guide element is preferably provided to be moved at least substantially parallel to the axis of rotation and/or the offset direction via the screw thread by rotation about the axis of rotation in order to adjust the width of the guide holder. The fixing means are preferably provided, via at least one stop on the holding unit, in particular on the holding element, to limit a movement of the guide element performed via the screw thread about the axis of rotation in at least one direction, and/or limit movement for at least one guiding position, in particular for the possible guiding positions.

It is further proposed that the other guide element comprise at least two guide faces on a side facing the guide element, each of the guide faces being provided to form another side face of the guide holder, the at least two guide faces of the other guide element being arranged offset with respect to one another at least substantially parallel to the extent of the width of the guide holder. An advantageous embodiment for use on saws having a centered guide of a saw blade can be enabled. In addition, an advantageously high number of different widths of the guide holder can be achieved in an embodiment of the guide elements which is simultaneously advantageously simple. It is conceivable that the guide faces of the other guide element and/or the other guide element be designed to be at least substantially identical to the guide faces of the guide element and/or identical to the guide element. Alternatively, it is conceivable that the guide faces of the other guide element have different spacings, at least substantially parallel to the extent of the width of the guide holder, than the guide faces of the guide element. Preferably, the guide element and the other guide element are provided to specify a respective width of the guide holder via a minimum spacing of two guide faces arranged in the region of the guide holder. Preferably, the guide element and the other guide element are each movably mounted, in particular rotatably, relative to the holding unit, in particular the holding element. In particular, the guide element and the other guide element are movably mounted, in particular rotatably, relative to one another. Preferably, the guide element and the other guide element are each mounted rotatably about the axis of rotation. In particular, the guide faces of the other guide element are arranged at least substantially in an evenly distributed manner about the axis of rotation. It is conceivable that the guide unit, in particular the other guide element, preferably substantially analogous to the guide element, comprises fixing means for fixing the other guide element relative to the holding unit, in particular relative to the holding element or another holding element of the holding unit. Alternatively or additionally, it is conceivable that the guide unit, in particular substantially analogous to the reset element, comprises at least one further reset element which is provided to counteract movement of the other guide element from one of the guiding positions. In particular, the guide faces of the other guide element are designed offset with respect to one another in the offset direction. Preferably, the guide faces of the other guide element are each substantially planar, at least in regions.

It is further proposed that the other guide element is movably coupled to the guide element, in particular rotatably about an axis of rotation, in order to adjust the width of the guide holder, whereby in the at least two guiding positions of the guide element and the other guide element, other respective guide faces of the guide element and the other guide element form the guide holder. Advantageously, a simple-to-operate saw blade guiding device can be achieved. Advantageously, a relative movement of the guide elements can be prevented. It is conceivable that the guide element and the other guide element can be integrally designed or designed movably in a coupled manner other than a movement about the axis of rotation. For example, the guide unit comprises at least one coupling element for rotationally coupling the the guide element and the other guide element. Preferably, the coupling element is designed as a pin, as a bolt, as a magnetic connection, or the like. Preferably, the coupling element is arranged between the guide element and the other guide element. The coupling element is preferably provided to connecting the guide element and the other guide element to each other in an interlocking and/or frictional manner at least during movement of the guide element and the other guide element about the axis of rotation. It is conceivable that the guide element and the other guide element be moved at least substantially parallel to the axis of rotation relative to one another given a design in which the connection between the guide element and the other guide element take places via the coupling element. For example, the guide element and the other guide element each delimit a guide recess for receiving the coupling element, the coupling element being arranged inside the guide recesses of the guide element and the other guide element. Preferably, the guide recesses together have a maximum longitudinal extent that is greater than a maximum longitudinal extent of the coupling element. In particular, the holding unit comprises at least one holding element, which is provided to cooperate with the guide element and/or the other guide element in order to fix the guide element and the other guide element relative to a rotation about the axis of rotation, in particular using fixing means. In particular, the holding element is provided to be at least temporarily separated from the guide element and/or the other guide element in order to disengage the guide element and the other guide element from a guiding position. For example, the holding element is provided to clamp the guide element and the other guide element along the axis of rotation using a reset force. In particular, the holding element is provided to be pushed apart from one another from a guiding position against the reset force in order to disengage the guide element and the other guide element, in particular whereby a fixing of the guide element and the other guide element against a rotation about the axis of rotation is disengaged. In particular, a guide face of the guide element and a guide face of the other guide element are respectively arranged in a row at a point about the axis of rotation, and are provided to form a guide holder having a width corresponding to a minimum spacing of the two guide faces.

It is also proposed that the guide element on the side facing the other guide element comprises three guide faces, each of which is provided to forming the side face of the guide holder, the three guide faces of the guide element being arranged offset with respect to one another at least substantially parallel to the extent of the width of the guide holder, and the three guide faces of the guide element being arranged at a regular distance distributed about the axis of rotation, the three guide faces each extending over an angular range of at least 90°, preferably at least 100°, and more preferably at least 110°, about the axis of rotation. An advantageously high number of guiding positions can be achieved, in particular while simultaneously maintaining sufficient depth of the guide recess and an advantageously compact embodiment of the guide element. In particular, the three guide faces are each arranged offset from one another by 120° around the axis of rotation. Alternatively or additionally, it is conceivable that the other guide element comprises three guide faces on the side facing the guide element, each of which is provided to form the other side face of the guide holder, the three guide faces of the other guide element being arranged offset with respect to one another at least substantially parallel to the extent of the width of the guide holder, the three guide faces of the other guide element being arranged at a regular distance distributed about the axis of rotation, the three guide faces each extending over an angular range of at least 90° about the axis of rotation. Preferably, the guide faces of the guide element and/or the other guide element are each designed at a distance from one another when viewed along the offset direction. Preferably, the guide faces of the guide element and/or the guide faces of the other guide element each extend along the offset direction as viewed from an outside of the respective guide element facing away from the axis of rotation over at least 10%, preferably at least 15%, and preferably at least 20%, of the maximum transverse extent of the respective guide element, corresponding in particular to a diameter of the respective guide element, oriented perpendicular to the axis of rotation.

In addition, a saw, in particular a jig saw, is proposed, having at least one saw blade guiding device according to the invention. Preferably, the saw blade guiding device is designed as part of the saw. The saw blade guiding device is preferably arranged on and/or below a tool holder of the saw and is provided to hold the saw blade. The saw blade guiding device is preferably arranged and/or designed such that the guide holder is designed to be open on a side of the guide holder facing away from the untoothed back of the saw blade.

Due to the embodiment of the saw according to the invention, an advantageously simple and fast changing of the width of the guide holder can be made possible during a saw blade change. An advantageously low-maintenance saw can be realized, in particular because contact points between the guide holder and the saw blade can advantageously be omitted. An advantageously compact saw can be made possible. An advantageously clear connection region for fastening the saw blade can be achieved.

The saw blade guiding device according to the invention and/or the saw according to the invention should not be limited to the application and embodiment described hereinabove. In particular, in order to fulfill a functionality described herein, the saw blade guiding device according to the invention and/or the saw according to the invention can comprise a number of individual elements, components, and units that deviates from a number mentioned herein. Moreover, regarding the ranges of values indicated in this disclosure, values lying within the limits specified hereinabove are also intended to be considered as disclosed and usable as desired.

### DRAWINGS

Further advantages will become apparent from the following description of the drawings. The drawings show three exemplary embodiments of the invention. The drawings, the description, and the claims contain numerous features in combination. A skilled person will appropriately also consider the features individually and combine them into additional advantageous combinations.

Shown are:

FIG. 1 a perspective illustration of a saw according to the invention, designed as a jig saw, having a saw blade guiding device according to the invention,

FIG. 2 a schematic sectional view of the saw blade guiding device according to the invention,

FIG. 3 a perspective view of a guide element of the saw blade guiding device according to the invention comprising three guide faces at a distance from one another,

FIG. 4 a side view of the guide element of the saw blade guiding device according to the invention,

FIG. 5 a perspective view of the saw blade guiding device according to the invention, with a holding unit and a guide unit,

FIG. 6 a perspective illustration of an alternative embodiment of a saw blade guiding device according to the invention for a saw according to the invention, the guiding device comprising two movable guide elements, each of which comprises a plurality of guide faces, and

FIG. 7 a schematic cross-sectional view of a further alternative embodiment of a saw blade guiding device according to the invention, comprising a guide element which is movable via a screw thread, the guide element comprising transitioning guide faces.

### DESCRIPTION OF THE EXEMPLARY EMBODIMENTS

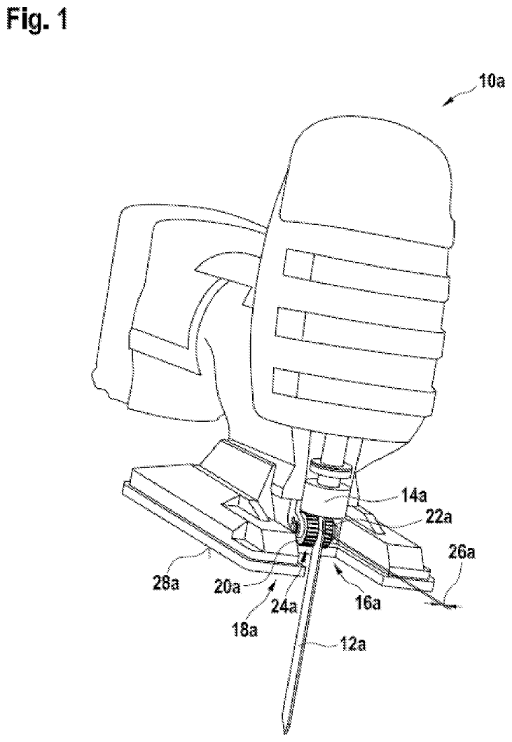

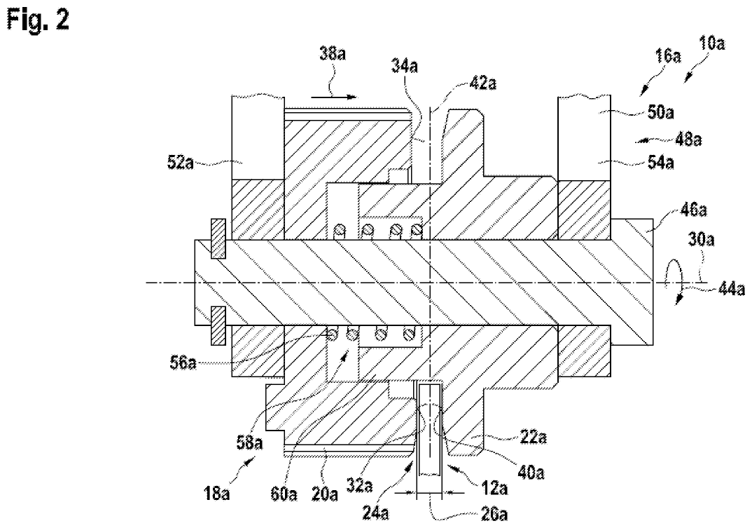

In FIG. 1, a perspective view of a saw 10a designed as a jig saw is shown. The saw 10a is designed as a hand-held machine tool in particular. The saw 10a is in particular designed to be battery operated. The saw 10a comprises a saw blade 12a, a tool holder 14a for fastening the saw blade 12a and a saw blade guiding device 16a for guiding the saw blade 12a during a sawing operation. Saw blade guiding device 16a is arranged below the tool holder 14a. The saw blade guiding device 16a comprises a guide unit 18a for guiding the saw blade 12a during a sawing operation. The guide unit 18a comprises two guide elements 20a, 22a (see FIG. 2), which are provided to together form a guide holder 24a for an untoothed saw blade back of the saw blade 12a. A width 26a of the guide holder 24a (see FIG. 2) is adjustable via the two guide elements 20a, 22a, preferably in order to guide saw blades 12a of different thicknesses. The saw blade guiding device 16a is preferably designed to be at a distance from a processing plane on which a workpiece to be processed by the saw 10a is arranged, the spacing created by a contact surface 28a of the saw 10a, the contact surface contacting the workpiece.

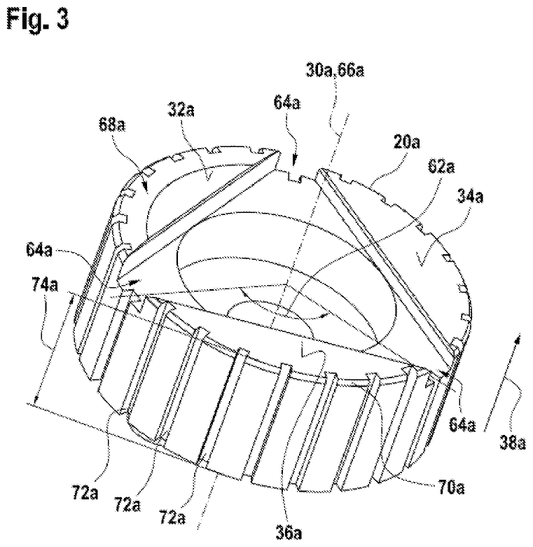

In FIG. 2, a sectional view of the saw blade guiding device 16a is shown, in particular whereby a sectional plane includes an axis of rotation 30a of the guide element 20a. One guide element 20a of the two guide elements 20a, 22a comprises, on a side facing the other guide element 22a of the two guide elements 20a, 22a, three guide faces 32a, 34a, 36a (see FIG. 3; only two are shown in FIG. 2), each of which is provided to form a side face of the guide holder 24a, in particular depending on a guiding position of the guide element 20a. Embodiments of the guide element 20a are also conceivable which have one of three different numbers of guide faces 32a, 34a, 36a, for example with only two guide faces 32a, 34a, 36a or with more than three, in particular four or five, guide faces 32a, 34a, 36a. The three guide faces 32a, 34a, 36a of the guide element 20a are arranged at least substantially parallel to an extent of the width 26a of the guide holder 24a offset from one another. The three guide faces 32a, 34a, 36a of the guide element 20a are formed on the guide element 20a offset from one another in an offset direction 38a. The guide element 20a is movably mounted in order to adjust the width 26a of the guide holder 24a, and features three different guiding positions; in the three guiding positions of the guide element 20a, another of the three guide faces 32a, 34a, 36a of the guide element 20a in each case forms a side face of the guide holder 24a. The guide holder 24a has a different value for the width 26a of the guide holder 24a for each of the guide faces 32a, 34a, 36a of the guide element 20a when arranged in a region of the guide holder 24a. In particular, the width 26a of the guide holder 24a is defined by the minimum spacing of the respective guide face 32a, 34a, 36a arranged in the region of the guide holder 24a of the guide element 20a from the other guide element 22a, in particular from a side face 40a of the other guide element 22a which is opposite to the respective guide face 32a, 34a, 36a in the region of the guide holder 24a in the offset direction 38a and which in particular forms another side face of the guide holder 24a. In particular, the guide holder 24a features a central plane 42a. Preferably, the central plane 42a extends perpendicular to the extent of the width 26a of the guide holder 24a. In particular, the guide holder 24a is designed such that a point on the side face comprising one of the respective guide faces 32a, 34a, 36a of the guide holder 24a, in particular one of the two side faces of the guide holder, said point being nearest to the central plane 42a when in a guiding position, lies within a planar surface of the guide element 20a or of the other guide element 22a, the planar surface being oriented parallel to the central plane 42a. Preferably, the guide element 20a, in particular the three guide faces 32a, 34a, 36a of the guide element 20a, are designed such that a maximum width 26a of the guide holder 24a is at most 4 mm, preferably at most 3 mm, and more preferably at most 2 mm. The guide element 20a, in particular the three guide faces 32a, 34a, 36a of the guide element 20a, are designed such that the width 26a of the guide recess 24a in the three guiding positions of the guide element 20a is at least substantially 1.8 mm, 1.5 mm and 1.2 mm.

The guide element 20a is rotatably designed in order to adjust the width 26a of the guide holder 24a about the axis of rotation 30a of the guide element 20a, whereby the three guide faces 32a, 34a, 36a of the guide element 20a are arranged offset from one another in a circumferential direction 44a about the axis of rotation 30a. The guide unit 18a comprises a bearing element 46a designed as a bolt for rotatably supporting the guide element 20a about the axis of rotation 30a. In particular, the guide element 20a is movably mounted at least on the bearing element 46a in a direction oriented at least substantially parallel to the axis of rotation 30a.

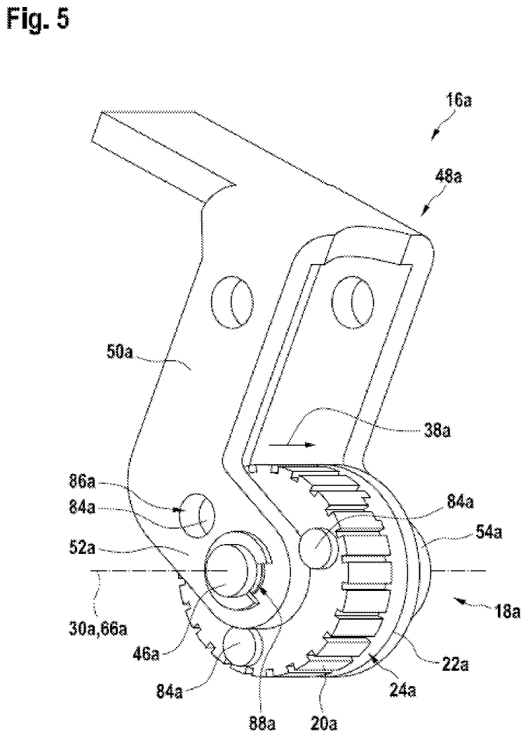

The saw blade guiding device 16a comprises a holding unit 48a, which is at least substantially fixed to the housing in order to retain the guide unit 18a. In particular, the holding unit 48a is provided in order to attach the saw blade guiding device 16a to the saw 10a. The holding unit 48a comprises a holding element 50a, which encompasses the guide element 20a like a bracket (see FIG. 5). The other guide element 22a is designed to be integral with the holding unit 48a, in particular with the holding element 50a. It is also conceivable that the other guide element 22a is designed separately from the holding element 50a, in particular the holding element 50a encompasses the guide element 20a and the other guide element 22a. The bearing element 46a is attached to the holding element 50a. In particular, the bearing element 46a provides the axis of rotation 30a of the guide element 20a. Preferably, the bearing element 46a is freely rotatable about the axis of rotation 30a. Alternatively, it is conceivable that the bearing element 46a is arranged in a non-rotational manner relative to the axis of rotation 30a, for example by fixing it to the retaining element 50a. Preferably, the holding element 50a limits movement of the guide element 20a in a direction oriented at least substantially parallel to the axis of rotation 30a. The bearing element 46a is in particular retained by a retaining pin and a head part of the bearing element 46a between two bracket portions 52a, 54a of the holding element 50a. In particular, the holding element 50a encompasses the guide unit 18a, in particular the guide element 20a via the bracket portions 52a, 54a, in particular in a region of the axis of rotation 30a (see FIG. 5).

The guide unit 18a comprises a reset element 56a, which is provided to counteract movement of the guide element 20a from one of the guiding positions. The reset element 56a is designed as a compression spring. The reset element 56a is arranged between the guide element 20a and the other guide element 22a. The reset element 56a is provided in order to apply a reset force to the guide element 20a when the holding element 50a, in particular, a bracket portion 52a of the holding element 50a against which the guide element 20a is seated in a guiding position, moves away in the direction of the other guide element 22a, the reset force being directed away from the other guide element 22a and/or toward the holding element 50a, in particular the bracket portion 52a of the holding element 50a, against which the guide element 20a is seated in a guiding position. The reset element 56a is arranged around the bearing element 46a. The reset element 56a is arranged centered relative to the axis of rotation 30a, particularly by the bearing element 46a. The guide element 20a and the other guide element 22a together delimit a recess 58a in a central region surrounding the bearing element 46a and/or surrounding the axis of rotation 30a, said recess being provided to hold the reset element 56a. The recess 58a is preferably designed to be at a distance from the guide holder 24a. In particular, the other guide element 22a forms an inner wall 60a, which delimits the guide holder 24a on one side of the inner wall 60a and delimits the recess 58a on another side of the inner wall 60a which faces away from the side of the inner wall 60a. Other embodiments of the guide unit 18a, in particular of the guide element 20a, the other guide element 22a and/or the reset element 56a are conceivable, for example whereby the guide element 20a forms the inner wall 60a, the reset element 56a is designed as a reset element other than a spring, the reset element 56a is designed as a tension spring, and in particular is arranged between the reset element 50a and the guide element 20a, or the like.

FIG. 3 shows a perspective view of the guide element 20a. The three guide faces 32a, 34a, 36a of the guide element 20a are arranged offset with respect to one another at least substantially parallel to the extent of the width 26a of the guide holder 24a. The three guide faces 32a, 34a, 36a of the guide element 20a are arranged at a regular distance distributed about the axis of rotation 30a. The three guide faces 32a, 34a, 36a of the guide element 20a each extend along an angular range 62a of at least 90°, preferably at least 100°, and preferably at least 110°, around the axis of rotation 30a. The three guide faces 32a, 34a, 36a are arranged at a distance from one another, in particular whereby a gap 64a is in each case formed between two adjacent guide faces of the three guide faces 32a, 34a, 36a. One guide face 32a of the three guide faces 32a, 34a, 36a comprises a tapered region 68a in an exterior region facing away from the axis of rotation 30a, or rather from a central axis 66a of the guide element 20a, whereby the guide face 32a is oriented oblique relative to the central plane 42a, and to the offset direction 38a or the axis of rotation 30a. In particular, the tapered region 68a is provided in order to simplify the holding of the saw blade 12a. The three guiding surfaces 32a, 34a, 36a are each at least substantially planar in regions. In particular, the guide element 20a in an outermost edge region of the three guide faces 32a, 34a, 36a each comprises a chamfer 70a. The guide unit 18a comprises actuating means 72a for actuating the guide element 20a in order to adjust the width 26a of the guide holder 24a. The actuating means 72a are provided to actuate the guide element 20a by a user given rotation of the guide element 20a about the axis of rotation 30a. The actuating means 72a are designed as groove-like recesses that are arranged in an evenly distributed manner about the axis of rotation 30a on the guide element 20a. In particular, the actuating means 72a are arranged in the circumferential direction 44a about the axis of rotation 30a distributed on a lateral surface of the guide element 20a. The actuating means 72a are delimited by guide element 20a. The actuating means 72a are designed to be integral with the guide element 20a. The actuating means 72a each extend beyond a maximum height 74a of the guide element 20a. The guide element 20a features a basic, at least substantially cylindrical, shape. The guide faces 32a, 34a, 36a are each shaped like at least substantially circular segments.

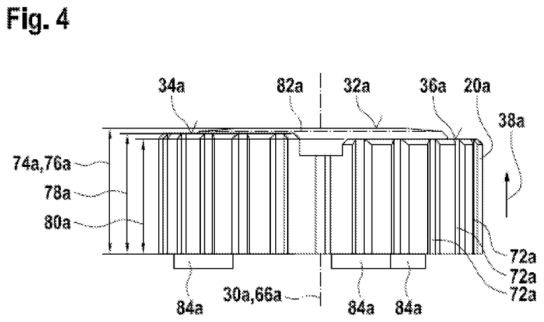

In FIG. 4, the guide element 20a is shown in a side view, in particular perpendicular to the axis of rotation 30a, i.e., to the central axis 66a of the guide element 20a. The guide element 20a features a different maximum height extension 76a, 78a, 80a in the regions of the three guide faces 32a, 34a, 36a, whereby in particular a maximum height extension 76a of the guide element 20a in a region of the guide face 32a corresponds to the maximum height 74a of the guide element 20a. The maximum height extensions 76a, 78a, 80a and/or the maximum height 74a of the guide element 20a are respectively oriented parallel to the offset direction 38a and/or the axis of rotation 30a. The guide faces 32a, 34a, 36a of the guide element 20a each have a main extension plane 82a (shown for example in FIG. 4 for the guide face 32a) which are respectively oriented at least substantially perpendicular to the axis of rotation 30a, i.e. the central axis 66a of the guide element 20a.

The guide unit 18a includes three fixing means 84a, each designed as a projection. The fixing means 84a are provided to fix the guide element 20a in at least one of the guiding positions relative to the holding unit 48a. The fixing means 84a are designed to be integral with the guide element 20a. The fixing means 84a are arranged on a side of the guide element 20a which faces away from a side of the guide element 20a which comprises the guide faces 32a, 34a, 36a. Each of the fixing means 84a extends from an outer wall of the guide element 20a at least substantially parallel to the axis of rotation 30a, i.e. the center axis 66a of the guide element 20a away from the guide element 20a, in particular in a direction facing away from the guide faces 32a, 34a, 36a. In particular, the fixing means 84a are each not included in the maximum height extensions 76a, 78a, 80a of the guide element 20a.

In FIG. 5, the saw blade guiding device 16a is shown in a perspective view. The individual fixing means 84a are provided to fix the guide element 20a to the holding unit 48a, in particular the holding element 50a, in one of the guiding positions in a frictional and/or interlocking manner. The fixing means 84a are arranged on the guide element 20a in an evenly distributed manner around the axis of rotation 30a, i.e., the central axis 66a of the guide element 20a. The holding element 50a delimits a recess 86a at a distance from the axis of rotation 30a, or rather from the bearing element 46a. The recess 86a delimited by the holding element 50a is designed to correspond, in particular with respect to a basic shape, to the individual fixing means 84a. In particular, the fixing means 84a and the recess 86a each have a basic shape that is at least substantially cylindrical. The bracket portion 52a of the holding element 50a delimits the recess 86a. The holding element 50a, particularly via the two bracket portions 52a, 54a, delimits a passage 88a for holding the bearing element 46a. Alternatively, other embodiments of the fixing means 84a and/or the holding element 50a are conceivable, for example having one of three different numbers of fixing means 84a, with more than one recess 86a, with a plurality of holding elements 50a each of which, in particular, forms a bracket portion 52a, 54a, and/or having a different basic shape of the fixing means 84a and the recess 86a. Particularly preferably, a number of fixing means 84a of the guide unit 18a corresponds to an integer multiple of the number of different guiding positions, or the number of different guide faces 32a, 34a, 36a of the guide element 20a.

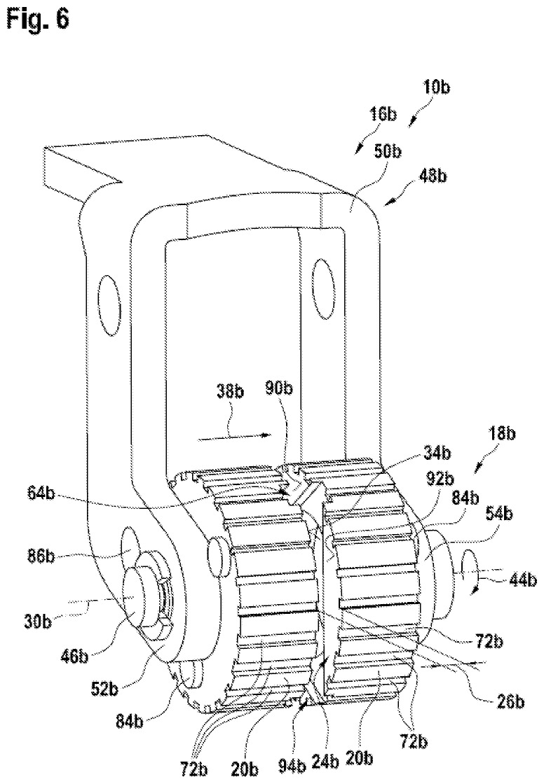

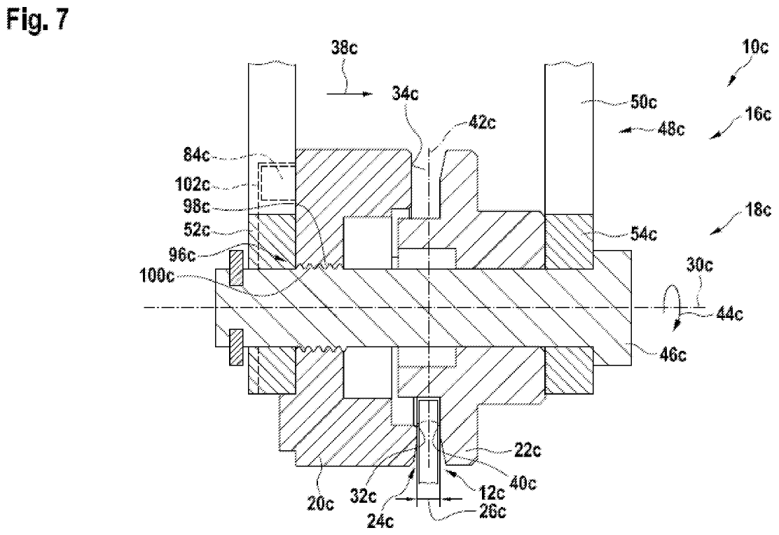

FIGS. 6 and 7 each show a further exemplary embodiment of the invention. The following descriptions and the drawings are essentially limited to the differences between the exemplary embodiments, whereby reference can in principle also be made with respect to identically designated components, in particular with respect to components having the same reference characters, to the drawings, and/or the description of the other exemplary embodiment, in particular FIGS. 1 to 5. In order to distinguish between the exemplary embodiments, the letter a is appended to the reference characters for the exemplary embodiment in FIGS. 1 to 5. The letter a is replaced by the letters b and c in the exemplary embodiments in FIGS. 6 and 7.

FIG. 6 shows a perspective view of an alternative embodiment of a saw blade guiding device 16b, which is in particular formed as part of a saw 10b. The saw blade guiding device 16b comprises a guide unit 18b for guiding a saw blade of the saw 10b (not shown in FIG. 6) in a sawing operation, whereby the guide unit 18b comprises two guide elements 20b, 22b, which are provided together for forming a guide holder 24b for the saw blade, in particular an untoothed saw blade back of the saw blade. A width 26b of the guide holder 24b is adjustable via the two guide elements 20b, 22b. One guide element 20b of the two guide elements 20b, 22b comprises three guide faces 32b, 34b, 36b on a side facing the other guide element 22b of the two guide elements 20b, 22b (only guide face 34b is shown in the drawing; see FIG. 3), each face being provided to form a side face of the guide holder 24b, in particular depending on a guiding position of the guide element 20b. The three guide faces 32b, 34b, 36b of the guide element 20b are arranged offset with respect to one another at least substantially parallel to an extent of the width 26b of the guide holder 24b. The guide element 20b features three guiding positions; in the three guiding positions of the guide element 20b, a different one of the three guide faces 32b, 34b, 36b of the guide element 20b in each case forms a side face of the guide holder 24b. The guide element 20b is designed to be rotatable about an axis of rotation 30b of the guide element 20b in order to adjust the width 26b of the guide holder 24b, whereby the three guide faces 32b, 34b, 36b of the guide element 20b are arranged offset with respect to one another in a circumferential direction 44b about the axis of rotation 30b. The embodiment of the saw blade guiding device 16b shown in FIG. 6 substantially corresponds to the saw blade guiding device 16a shown in FIGS. 1 to 5. The saw blade guiding device 16b shown in FIG. 6 differs from the saw blade guiding device 16a shown in FIGS. 1 to 5 in that the other guide element 22b of the guide unit 18b is formed separately from a holding unit 48b of the saw blade guiding device 16b, in particular a holding element 50b of the holding unit 48b. The other guide element 22b comprises three guide faces 90b, 92b, 94b on one side facing the guide element 20b and each provided to form another side face of the guide holder 24b, the three guide faces 90b, 92b, 94b of the other guide element 22b being arranged offset with respect to one another at least substantially parallel to the extent of the width 26b of the guide holder 24b. The other guide element 22b is designed to be coupled to the guide element 20b rotatably about the axis of rotation 30b in order to adjust the width 26b of the guide holder 24b, whereby, in the three guiding positions of the guide element 20b and the other guide element 22b, other respective guide faces 32b, 34b, 36b, 90b, 92b, 94b of the guide element 20b and the other respective guide element 22b form the guide holder 24. Preferably, the guide element 20b and the other guide element 22b each include fixing means 84b for fixing the guide elements 20b, 22b relative to the holding element 50b, in particular to a respective bracket portion 52b, 54b of the holding element 50b. The guide unit 18b comprises a reset element 56b designed as a compression spring which is arranged between the guide element 20b and the other guide element 22b (not shown in FIG. 6, similar to FIG. 2). The reset element 56b is particularly provided to apply a reset force to the guide element 20b and the other guide element 22b that acts in opposite directions on the guide element 20b and on the other guide element 22b. In particular, the reset element 56b is provided to push the guide element 20b and the other guide element 22b apart, in particular onto a respective bracket portion 52b, 54b of the holding element 50b. Preferably, the guide element 20b and the other guide element 22b are provided to cooperate with a respective recess 86b delimited by the holding element 50b via the fixing means 84b in the guiding positions. In particular, the holding element 50b delimits two recesses 86b for receiving one of the fixing means 84b, whereby the recesses 86b are respectively arranged on one of the bracket portions 52b, 54b of the holding element 50b. One of the recesses 86b is particularly provided for a connection to a fixing means 84b arranged on the guide element 20b. Another of the recesses 86b is particularly provided for a connection to a fixing means 84b arranged on the other guide element 22b. In particular, the guide elements 20b, 22b are provided to be pressed together against the return force of the reset element 56b in order to adjust the width 26b of the guide holder 24b, whereby the fixing means 84b disengage from the recesses 86b and the guide element 20b and the other guide element 22b are rotatable about the axis of rotation 30b. Preferably, the guide unit 18b comprises a coupling element (not shown in the drawings) designed as a pin for coupling the two guide elements 20b, 22b when rotated about the axis of rotation 30b. In particular, the coupling element extends at least substantially parallel to the axis of rotation 30b. Preferably, the coupling element is arranged between the two guide elements 20b, 22b. The guide element 20b and the other guide element 22b have an at least substantially identical cylindrical basic shape. The other guide element 22b, like the guide element 20b, comprises actuating means 72b (see FIG. 3).

In FIG. 7, a schematic sectional view of a further alternative embodiment of a saw blade guiding device 16c is shown, in particular whereby a sectional plane includes an axis of rotation 30c of a guide element 20c of a guide unit 18c of the saw blade guiding device 16c. The saw blade guiding device 16c is designed as part of a saw 10c. The saw blade guiding device 16c comprises the guide unit 18c for guiding a saw blade of the saw 10c (not shown in FIG. 7) during a sawing operation, whereby the guide unit 18c comprises two guide elements 20c, 22c which are provided to together form a guide holder 24c for the saw blade, in particular an untoothed saw blade back. A width 26c of the guide holder 24c is adjustable via the two guide elements 20c, 22c. The guide element 20c of the two guide elements 20c, 22c comprises a plurality of guide faces 32c, 34c on a side facing the other guide element 22c of the two guide elements 20c, 22c, each of the guide faces being provided to form a side face of the guide holder 24c, in particular depending on a guiding position of the guide element 20c. The guide faces 32c, 34c of the guide element 20c are arranged offset with respect to one another at least substantially parallel to an extent of the width 26c of the guide holder 24c. The guide element 20c features a plurality of guiding positions, whereby in each of the guiding positions of the guide element 20c, a different one of the guide faces 32c, 34c of the guide element 20c forms a side face of the guide holder 24c. The guide element 20c is designed to be rotatable about the axis of rotation 30c of the guide element 20c in order to adjust the width 26c of the guide holder 24c. The embodiment of the saw blade guiding device 16c shown in FIG. 7 substantially corresponds to the saw blade guiding device 16a shown in FIGS. 1 to 5. The saw blade guiding device 16c shown in FIG. 7 differs from the saw blade guiding device 16a shown in FIGS. 1 to 5 in that the guide unit 18c comprises a screw thread 96c for moving the guide element 20c along the axis of rotation 30c in order to adjust the width 26c of the guide holder 24c. The guide element 20c forms an inner thread 98c for the screw thread 96c on an inside facing the axis of rotation 30c. A bearing element 46c of the guide unit 18c, about which the guide element 20c in particular is rotatable, forms an outer thread 100c of the screw thread 96c on an outer side facing the guide element 20c, the outer thread in particular being designed to correspond to the inner thread 98c. The guide element 20c is provided to be moved along the bearing element 46c at least substantially parallel to the axis of rotation 30c via the screw thread 96c in order to adjust the width 26c of the guide holder 24c by means of the guide faces 32c, 34c, in particular whereby another of the guide faces 32c, 34c of the guide element 20c is in each case arranged in a region of the guide holder 24c. It is conceivable that the guide faces 32c, 34c are each formed oblique to a plane extending perpendicular to the axis of rotation 30c, in particular a central plane 42c of the guide holder 24c. In particular, it is conceivable that the obliquely formed guide faces 32c, 34c are arranged flush with each other along a circumferential direction 44c about the axis of rotation 30c, and preferably form a common guide face 32c, 34c that extends spirally about the axis of rotation 30c. By means of the obliquely formed guide faces 32c, 34c, an advantageously continuous, in particular continuously variable, adjustment of the width 26c of the guide holder 24c can be made possible upon rotation of the guide element 20c about the axis of rotation 30c. The guide element 20c forms a fixing means 84c which is arranged as a projection on an outside of the guide element 20c facing away from the side comprising the guide faces 32c, 34c. In particular, a holding element 50c of a holding unit 48c of the saw blade guiding device 16c delimits at least one stop 102c for cooperating with the fixing means 84c in at least one position of the guide element 20c, in particular one guiding position. Other embodiments of the guide unit 18c, in particular of the screw thread 96c, the guide element 20c, and/or the fixing means 84c are also conceivable. For example, it is conceivable that the guide unit 18c comprise a fixing means 84c or a plurality of fixing means 84c for fixing the guide element 20c in a position about the axis of rotation 30c independent of a specified guiding position, e.g. by means of clamping and/or via a spring-loaded and/or fixable, frictional connection between the holding element 50c and the guide element 20c.

1. A saw blade guiding device for a saw, comprising:
at least one guide unit configured to guide a saw blade of the saw in a sawing operation, the at least one guide unit comprising two guide elements, which together form a guide holder for the saw blade, the guide holder having a width that is adjustable by the two guide elements,
wherein at least one guide element of the two guide elements has, on a side facing the other guide element of the two guide elements, at least two guide faces, each of which is configured to, depending on a guiding position of the guide element, form a side face of the guide holder, and
wherein the at least two guide faces of the guide element are arranged offset with respect to one another at least substantially parallel to an extent of the width of the guide holder.

2. The saw blade guiding device according to claim 1, wherein:
the at least one guide element is movably mounted such that movement of the at least one guide elements adjusts the width of the guide holder and
the at least one guide element has at least two guiding positions and, in a first guiding position of the at least two guiding positions, a first guide face of the at least two guide faces forms the side face of the guide holder and, in a second guiding position of the at least two guiding positions, a second guide face of the at least two guide faces forms the side face of the guide holder.

3. The saw blade guiding device according to claim 2, wherein:
in order to adjust the width of the guide holder, the guide element is rotatable about an axis of rotation of the guide element, and
the at least two guide faces of the guide element are arranged offset in a circumferential direction with respect to one another about the axis of rotation.

4. The saw blade guiding device according to claim 2, further comprising:
at least one holding unit, which is at least substantially fixed to a housing in order to retain the at least one guide unit,
wherein the at least one guide unit comprises at least one fixing structure,
wherein the at least one guide element is movably mounted relative to the at least one holding unit in order to adjust the width of the guide holder, and
wherein the at least one fixing structure is configured to fix the at least one guide element in at least one of the at least two guiding positions relative to the holding unit.

5. The saw blade guiding device according to claim 4, wherein:
the at least one fixing structure includes a plurality of fixing structures arranged on the at least one guide element, and
individual fixing structures of the plurality of fixing structures are configured to fix the guide element to the at least one holding unit in one of the at least two guiding positions in a frictional and/or interlocking manner.

6. The saw blade guiding device according to claim 2, wherein the at least one guide unit comprises at least one reset element configured to counteract movement of the at least one guide element from one of the at least two guiding positions.

7. The saw blade guiding device according to claim 2, wherein
the other guide element comprises at least two further guide faces on a side facing the at least one guide element, each of the two further guide faces forming another side face of the guide holder, and
the at least two further guide faces of the other guide element are arranged offset with respect to one another at least substantially parallel to the extent of the width of the guide holder.

8. The saw blade guiding device according to claim 7, wherein:
the other guide element is configured to be movably coupled to the at least one guide element to adjust the width of the guide holder, and
in the at least two guiding positions of the guide element and the other guide element, other respective guide faces of the guide element and the other guide element form the guide holder.

9. The saw blade guiding device according to claim 3, wherein:
the at least two guide faces comprises three guide faces, each of which is configured to form the side face of the guide holder,
the three guide faces are arranged offset with respect to one another at least substantially parallel to the extent of the width of the guide holder, wherein
the three guide faces are arranged at a regular distance distributed about the axis of rotation, and
the three guide faces each extend over an angular range of at least 90° about the axis of rotation.

10. A jig saw, comprising:
at least one saw blade guiding device comprising:
at least one guide unit configured to guide a saw blade of the saw in a sawing operation, the at least one guide unit comprising two guide elements, which together form a guide holder for the saw blade, the guide holder having a width that is adjustable by the two guide elements,
wherein at least one guide element of the two guide elements has, on a side facing the other guide element of the two guide elements, at least two guide faces, each of which is configured to, depending on a guiding position of the guide element, form a side face of the guide holder, and
wherein the at least two guide faces of the guide element are arranged offset with respect to one another at least substantially parallel to an extent of the width of the guide holder.

11. The saw blade guiding device according to claim 1, wherein the saw blade guiding device is configured for a jigsaw.

12. The saw blade guiding device according to claim 1, wherein the guide holder is configured to guide an untoothed saw blade back.

13. The saw blade guiding device according to claim 1, wherein the guide holder is configured to guide an untoothed saw blade back.

14. The saw blade guiding device according to claim 8, wherein the other guide element is movably coupled to the at least one guide element in a rotatable manner about an axis of rotation.
